(19) United States
(12) Patent Application Publication
(10) Pub. No.: US 2011/0261184 A1
(43) Pub. Date: Oct. 27, 2011

(54) OPTICAL MICROSCOPE METHODS AND APPARATUSES

(76) Inventors: Michael S. Mason, Portland, OR (US); M. Mark Walker, Hillsboro, OR (US)

(21) Appl. No.: 13/124,652

(22) PCT Filed: Oct. 16, 2009
(86) PCT No.: PCT/US2009/061097

§ 371 Date: Jul. 12, 2011

Related U.S. Application Data
(60) Provisional application No. 61/106,486, filed on Oct. 17, 2008.

(51) Int. Cl. H04N 7/18; G02B 21/00

(52) U.S. Cl. 348/79; 359/380; 348/E07.085

(57) ABSTRACT

Embodiments provide microscopes, and more specifically, embodiments provide improvements to zoom control, viewing, and light management in microscopes particularly suited for surgery. These improvements include a compact zoom control system that provides enhanced surgical workspace, ergonomics, and optics, as well as improved methods for controlling a stereomicroscope light source and a novel auxiliary viewing system.

### CROSS REFERENCE TO RELATED APPLICATIONS

The present application claims priority to U.S. Provisional Patent Application No. 61/106,486, filed Oct. 17, 2008, entitled “OPTICAL MICROSCOPE METHODS AND APPARATUSES,” the entire disclosure of which is hereby incorporated by reference in its entirety.

### TECHNICAL FIELD

The present invention relates to microscopes, and in particular to improvements to zoom control, viewing, and light management in microscopes particularly suited for surgery.

### BACKGROUND

High powered and refined microscopes are often used by surgeons for performing delicate surgeries, such as eye and brain surgery. Currently, most surgical microscopes have a physical and optical configuration that puts the surgeon in an unnatural viewing vs. operating position. By virtue of the viewing angle and configuration, most microscopes direct the surgeon's eyes away from, rather than coincident with, the work area (see, e.g., FIG. 1A). U.S. Pat. No. 4,964,708, the disclosure of which is incorporated herein by reference, teaches a novel approach to solving this problem, having the optical viewing angle intersect with the light path at the surgical field (see, e.g., FIG. 1B).

Another problem with current surgical microscopes is that the light intensity can have adverse effects on the patient, particularly when eye surgery is being performed. Additionally, a surgeon's assistant has a set of eye pieces that they must look through to properly assist the surgeon. Accessibility, movement, and viewing through this accessory viewing component is extremely limited and hampers the ability of the assistant to properly assist the surgeon.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings, photographs and other renderings. Embodiments of the invention are illustrated by way of example and not by way of limitation in the accompanying renderings.

FIG. 1A illustrates a typical microscope and the associated viewing angles and distances;

FIG. 1B illustrates a microscope as set forth in commonly owned U.S. Pat. No. 4,964,708;

FIG. 2 illustrates a microscope in accordance with various embodiments of the present invention;

FIG. 3 illustrates an exploded view of the a carrier movement system for a microscope in accordance with various embodiments of the present invention;

FIG. 4 illustrates a cross section view of a lens carrier and cam system for a microscope in accordance with various embodiments of the present invention;

FIG. 5 illustrates a splayed schematic view of a cam, showing an optics configuration in accordance with various embodiments of the present invention;

FIG. 6 illustrates a section view of a cam and cam driver system for a microscope in accordance with various embodiments of the present invention;

FIGS. 7A and 7B illustrate a two views of an accessory viewing system for a microscope in accordance with various embodiments of the present invention; and

FIG. 8 illustrates several possible positions for an adjustable accessory viewing system and mount in accordance with various embodiments of the present invention.

FIG. 9 illustrates a schematic diagram of an exemplary AUTO-TRAK method.

FIG. 10 illustrates a schematic diagram of an exemplary AUTO-TRAK/SAFE-MODE method.

FIG. 11 illustrates a schematic diagram of another exemplary AUTO-TRAK/SAFE-MODE method.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “in an embodiment” or “in embodiments,” which may each refer to one or more of the same or different embodiments. Furthermore, the terms “comprising,” “including,” “having,” and the like, as used with respect to embodiments, are synonymous.

In various embodiments, a surgical microscope is provided that includes features that improve the use and functionality of the microscope during precise surgical operations, such as eye surgery, ear surgery, and neurosurgery. In one embodiment, an improved zoom control system and method of use are provided. The zoom control system may include a plurality of lens carriers that are coupled to a solid cylindrical cam via a corresponding plurality of grooves in the cam. Rotation of the solid cylindrical cam causes the lens carriers (and the lenses they carry) to move axially with respect to each other in such a way as to increase and decrease the zoom level of the microscope. The compact design of the zoom control device provides greater freedom of movement for the surgeon and assistants, while also improving the optics and light gathering properties of the microscope.

In another embodiment, in combination with or separate from the zoom control system, a light management system is provided. The light management system regulates the light source of the microscope in order to maintain a constant level of light intensity across all zoom levels. In addition, the system includes, in some embodiments, a light intensity limit that prevents phototoxic injury of the patient during light-sensitive procedures such as eye surgeries. Also included in some embodiments is a safe start-up light intensity setting, which limits the initial light intensity to a safe percentage of the maximum safe level.

Further embodiments include, in combination with or separate from the zoom control system and light management system, is an accessory viewing monitor that provides a more ergonomic viewing arrangement for a surgical assistant than current accessory viewing systems. The system may include a monitor, such as an LCD, LED, or plasma monitor that is coupled to the microscope and is adapted to be rotatable about a light path axis of the microscope. The monitor can be rotated about the microscope in order to be viewable by one or more assistants from a variety of angles or perspectives about the microscope. In some embodiments, the monitor can also be rotated about a transverse axis so that the assistant can obtain an image that is positionally accurate for the viewing angle. In particular embodiments, the monitor image can be rotated automatically (either mechanically or electronically) so that the screen image is always in the correct orientation to give a viewer a positionally accurate view of the surgical field.

### 1. Compact Zoom Control System

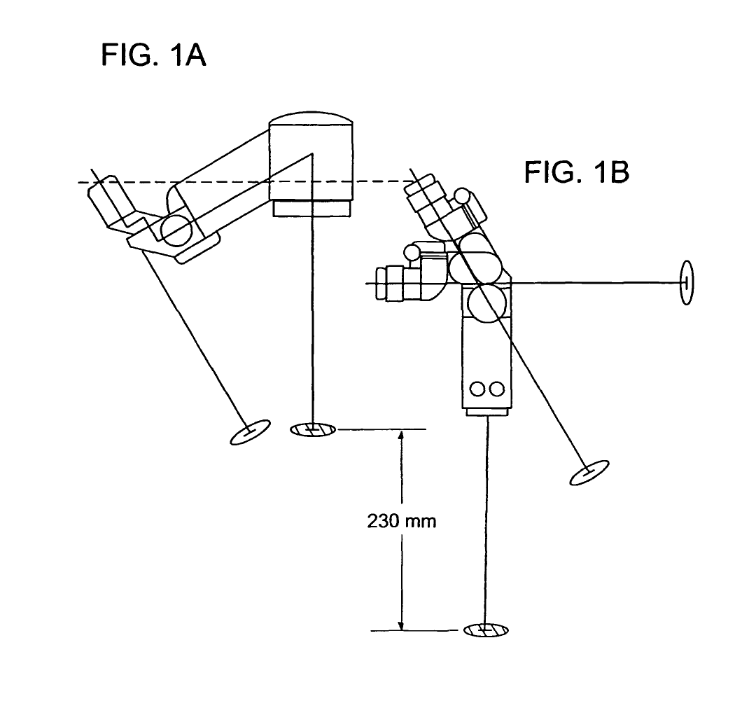

In various embodiments, a compact zoom control system for a surgical microscope is provided that can allow for positioning and control of the optics in a more flat and/or compact configuration. This is contrasted with current systems that use a traditional cylindrical optical zoom system (see, e.g., FIG. 1A) where the lenses are disposed within an interior portion of the cylindrical zoom control body. Such traditional systems are limited by an undesirably large distance from the eyepiece to the operating zone or surgical field, which both reduces operating space at the surgical work zone and requires the surgeon to work with his or her hands at an awkward distance from his or her body, causing ergonomic problems.

By contrast, the compact zoom control systems described herein in various embodiments may allow for a shorter distance between the viewing piece and the surgical working area. For example, in one embodiment, such a system may allow for about 12 inches of spacing between the focal point and the bottom of the microscope, which allows for a safe range of movement, even with optional accessories attached, but also brings the field of operation closer to the surgeon. Additionally, the zoom control systems disclosed herein may allow for coincidence of the viewing area and the working area, as illustrated in FIG. 1B. In various embodiments, a solid cylindrical cam may be used to control multiple of lenses for magnification, for example, of 4 to 20 times (or more) zoom control of stereo optical paths, and be packaged in a more compact manner so as to allow the coincident viewing described with respect to FIG. 1A.

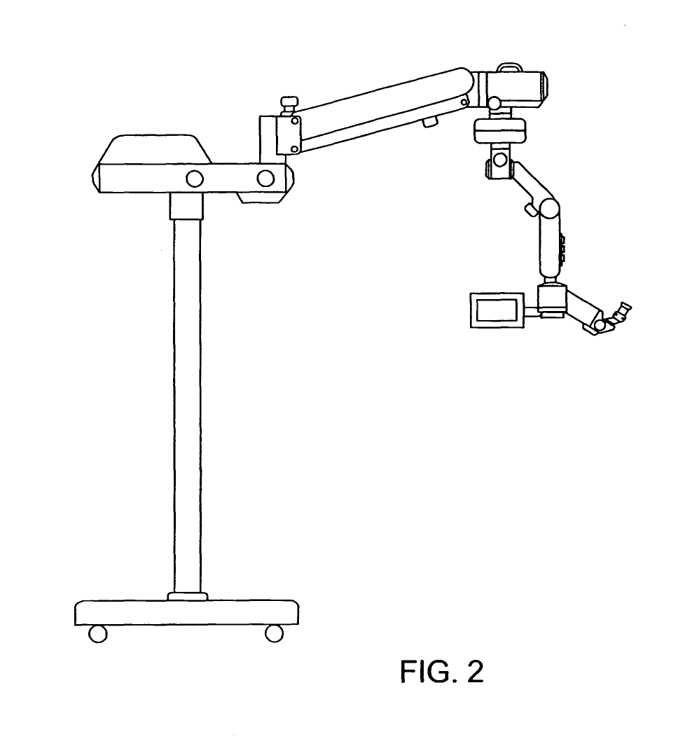

FIG. 2 illustrates an example of a microscope in accordance with various embodiments. Although preferred embodiments include an eyepiece that is angled such that the projected line of sight through the eyepiece substantially coincides or intersects with the work area, in some embodiments a traditional eyepiece, such as the one shown in FIG. 1B, may be substituted. This may be preferable to the surgeon who is accustomed to using a traditional surgical scope. Such a traditional eyepiece can be rotated into a variety of positions to suit the individual preference of the surgeon.

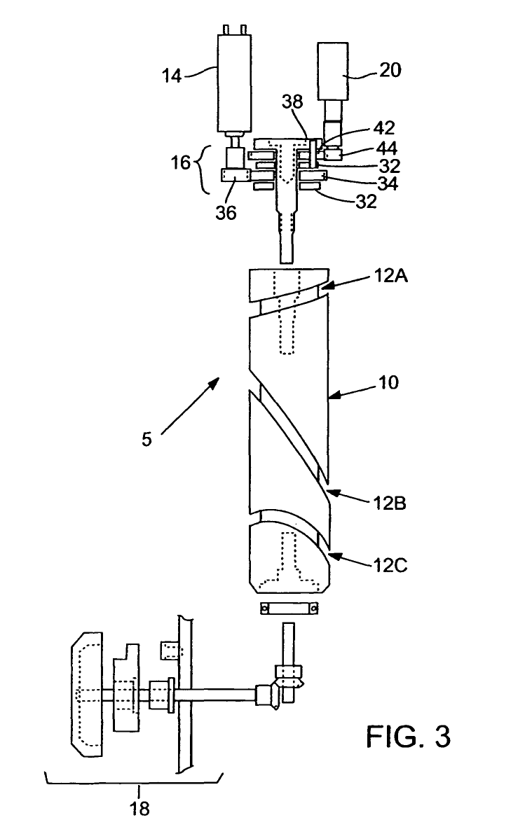

FIG. 3 illustrates an exploded view of a compact zoom control system 5 in accordance with various embodiments. The system generally may include a solid cylindrical cam 10 having grooves 12A, 12B and 12C. A motor 14 may be coupled to a cam drive system 16, and adapted to rotate the solid cylindrical cam 10. A manual override system 18 may be coupled to the solid cylindrical cam 10, and configured to manually control rotation of the solid cylindrical cam. A position sensor 20 may be coupled to the solid cylindrical cam to monitor the position of the solid cylindrical cam and to provide feedback to a control system. In various embodiments, the position sensor 20 is a potentiometer.

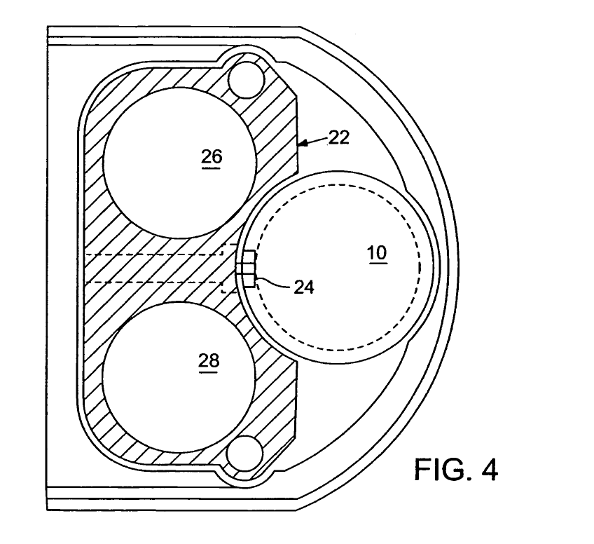

In various embodiments, the plurality of grooves in the solid cylindrical cam 10 may interface with a corresponding plurality of cam followers that control positioning of the lenses and/or lens carriers. As illustrated in FIG. 4, for example, a lens carrier 22 may be coupled to a groove in the solid cylindrical cam using a cam follower 24. Rotation of the solid cylindrical cam and thus the groove causes movement of the cam follower and carrier. This movement may adjust the zoom by movement of various lens pairs 26 and 28 relative to other lens carriers and lens pairs. In various embodiments, any number of grooves, carriers, cam followers may be used to move pairs of lenses axially relative to each other.

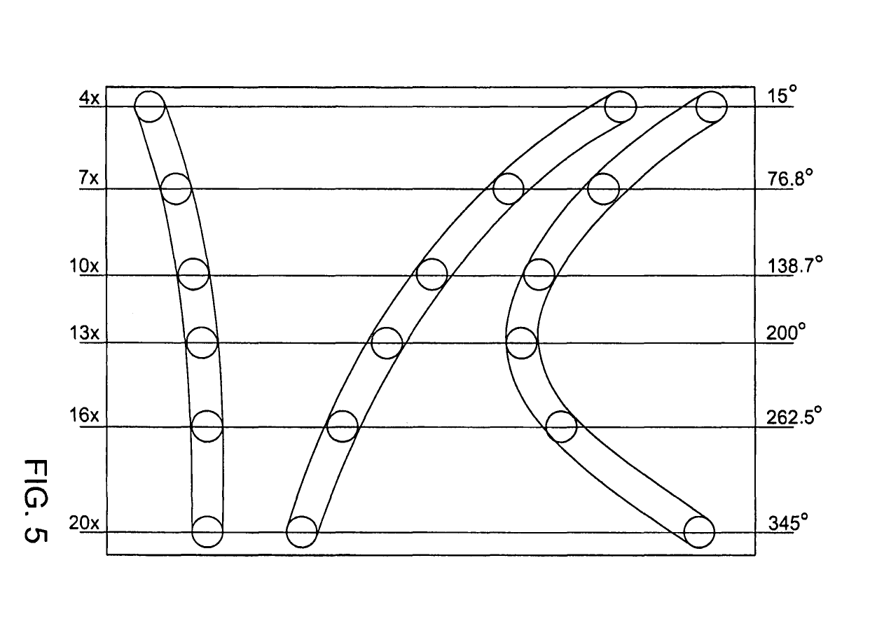

In one embodiment, the solid cylindrical cam 10 includes three grooves that control the movement of three lens carriers. For example, groove 12A may control movement of a field lens carrier; groove 12B may control the movement of the erector cell lens; and groove 12C may control the movement of the Barlow lens carrier. In various embodiments, movement of the solid cylindrical cam can control precise relative movement of the various lenses in order to provide variable magnification, for example from 4-20× or more (see, e.g., FIG. 5). In various embodiments, the solid cylindrical cam may be configured to rotate a total of 330 degrees in order to cause the lens carriers to move through various points in the magnification range. In other embodiments, the solid cylindrical cam may be configured to rotate more or less than 330 degrees depending on the number of lens carriers used, the lenses, and the operation being performed.

In various embodiments, using a solid cylindrical cam allows the lens carrier to be positioned partially surrounding and generally on opposite sides of the solid cylindrical cam, which contributes to a more compact design, as shown in FIG. 4. As discussed above, such a placement of the lens carriers helps maintain a lower profile and allows a more compact instrument body, as shown in FIG. 2, which may permit greater freedom of movement in and around the surgical work zone. In addition, the non-cylindrical design of the compact zoom control system and housing enables a widening of the objective lens spacing, thus giving a significant improvement in depth of field and 3D viewing not previously achieved. For instance, in various embodiments, the objective spacing may be increased from a standard of about 24 mm to 35-40 mm or more. In one specific, non-limiting example, the objective spacing may be about 38 mm. In some embodiments, the objective spacing may be about 50%, 55%, 60%, 65%, or 70% (or even more) wider than the industry standard spacing of 24 mm. In one specific, non-limiting example, the objective spacing is about 58% wider than the industry standard spacing.

Another advantage of the non-cylindrical compact zoom control is that the wider body can, in some embodiments, accommodate larger diameter objective lenses compared to the standard cylindrical zoom control. The narrowest point in the light path of a microscope is referred to as the limiting aperture. The limiting aperture limits the amount of light that can pass through the microscope (e.g., the throughput). Thus, a microscope that can accommodate larger lenses may have a larger limiting aperture, and may permit more light to enter the microscope. This, in turn, permits the use of a lower intensity light source without loss of optical image quality, according to some embodiments. In various embodiments, the microscopes described herein may have an limiting aperture of greater than about 8 mm, for instance about 8.5 mm, 9 mm, 9.5 mm, 10 mm, 10.5 mm, 11 mm, 11.5 mm, 12 mm, or even larger. In one specific, non-limiting embodiment, the limiting aperture may be 11.6 mm.

The greater light-gathering capability of the disclosed compact zoom control is particularly advantageous during eye surgery, when excessive light exposure can cause tissue damage. In other embodiments, the greater light-gathering capability may permit the use of alternative light sources, such an LED light source or a xenon, metal halide, or argon arc lamp in lieu of a halogen lamp, without loss of image quality. In still other embodiments, a conventional light source (e.g., halogen lamp) may be used with the disclosed compact zoom control in order to generate superior optical images than those obtainable with traditional, smaller objective lenses.

Yet another advantage of the compact zoom control in accordance with various embodiments is that the wider objective spacing may permit more light to be injected from a central location respective to and/or between the lenses, as opposed to off to one side. In some embodiments, this can improve light penetration in deep cavity or canal work. When a surgical procedure is performed in a deep cavity or canal, the light used to illuminate the surgical field is easily shielded by the entrance perimeter of the cavity or canal. Accordingly, it is preferable that the optical axis of an illuminating beam be as closely aligned as possible with the optical axis of observation. Thus, in some embodiments, the wider objective spacing may permit more light to travel substantially parallel with the axis of observation, which can allow more illumination to reach the surgical field, thereby improving the optical image quality.

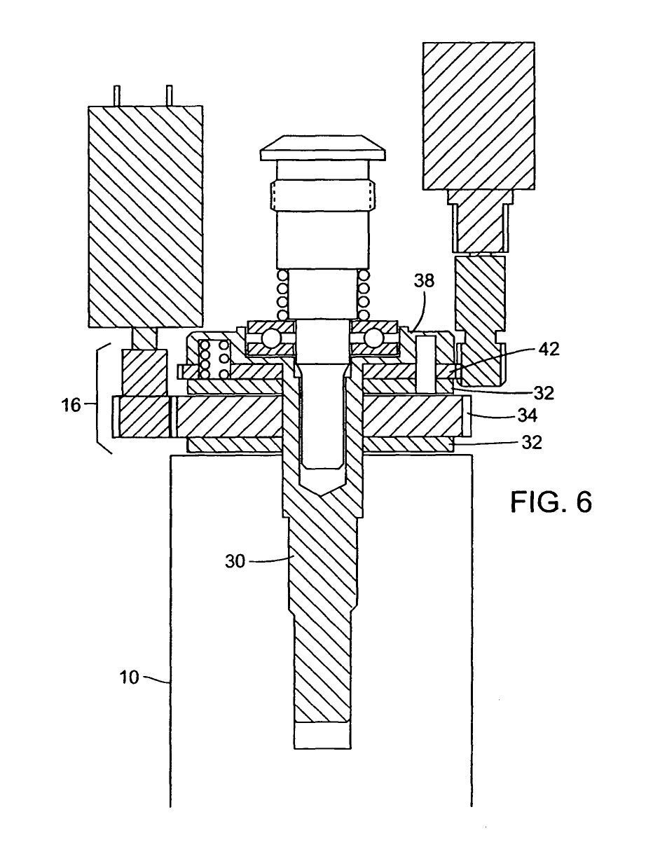

As illustrated in greater detail in FIG. 6, the cam drive system 16 may include a multi-gear system located at one end of the cam. In various embodiments, the drive system 16 may include a slip interface or slip couping, such as a slip clutch mechanism to enable the driven gears to be disengaged or overrun when, for example, the cam has rotated to a maximum rotation point, or where the manual override is invoked. The slip action may protect the cam and the optical elements.

In various embodiments, the drive system may include a central drive 30, which is coupled to and engages the solid cylindrical cam 10. Disposed about central drive 30 may be one or more friction plates 32 coupled to the central drive 30 and disposed about a slip disc 34. Slip disc 34 may be driven by motor 14 (also see, e.g., FIG. 3). Thus rotation of the motor gear 36 may cause rotation of slip disc 34. By virtue of engagement with friction discs 32, such rotation of slip disc 34 may cause rotation of the cam in a desired direction. When a rotation stop is encountered or a manual override input is received, the coefficient of friction between the slip disc and the friction plates is overcome and the rotation of the cam by the motor may be stopped.

In various embodiments, a loading member 38 may be used to controllably adjust the pressure on the friction plates in order to alter the coefficient of friction between the slip disc and the friction plates. This may allow for the override to occur at a user specified force. One or more biasing members, such as coil springs, may be disposed such that engagement of the loading member 38 adjusts the force applied by the biasing members on the friction plates. Accordingly, in various embodiments, the cam may be adjustably coupled to the drive system, wherein adjusting the tension on the integrated slip clutch can allow both manual and motorized control along with accurate tracking of position for digital display of magnification.

In various embodiments, the zoom control system 5 may also include a position gear 42 coupled to the central drive 30, such that it may rotate with the rotation of the solid cylindrical cam (also see, e.g., FIG. 3). Position sensor gear 44 is coupled to position gear 42. The position sensor 20 (e.g., zoom sensor) may then sense the position of the solid cylindrical cam over its range of rotation. In one embodiment, the sensor 20 may be a multi-turn (e.g., 10 turn) sensor, which allows use of a smaller position sensor gear, thereby helping to reduce the overall size of the zoom control system. The position sensor (e.g., zoom sensor) may provide the position information to a control system, which may be or include a microprocessor. Such position information may allow for a relatively precise magnification at any point. Further, as discussed below, the controller may use the position data (e.g., the zoom power) and thus control the light intensity as the magnification changes.

In various embodiments, the zoom sensor can be any type of sensor capable of detecting the zoom power or a zoom position. For instance, the zoom sensor may detect the position of the solid cylindrical cam as described above, or it may detect the position of one or more of the cam grooves, one or more of the lenses or lens carriers, or another movable component of the zoom system. This positional information may then be processed to determine the zoom power.

In various embodiments, a variety of drive mechanisms may be used. Further, other position sensing devices may be used that are coupled to and interface with the drive mechanism, or that are independent and monitor the position of the cam or lens carriers, such as vision systems. Further, two or more lens carriers may be configured to interface with the cam in order to modify the viewing configuration, zoom potential, or other vision parameter.

### 2. Light Management and Control

Systems in accordance with various embodiments, may allow for significant improvements in light control throughout multiple stages of microscope use, from initial start up to control during use. Generally, the perceived light intensity varies depending on the level of zoom employed. For instance, if the light intensity is adjusted to a desired level while at low zoom power, the same light intensity level may appear undesirably dim at high zoom power. Conversely, if the light intensity is adjusted to a desired level while at high zoom power, the same light intensity level may appear undesirable bright at low zoom power. Both low light intensity and high light intensity can lead to poor optical image quality. In current microscopes, the light intensity generally must be adjusted manually after a zooming operation. By contrast, in various embodiments disclosed herein, the light intensity may be automatically adjusted as the lenses are moved relative to each other in order to increase or decrease magnification. In one embodiment, as the magnification increases, so may the light intensity and visa versa.

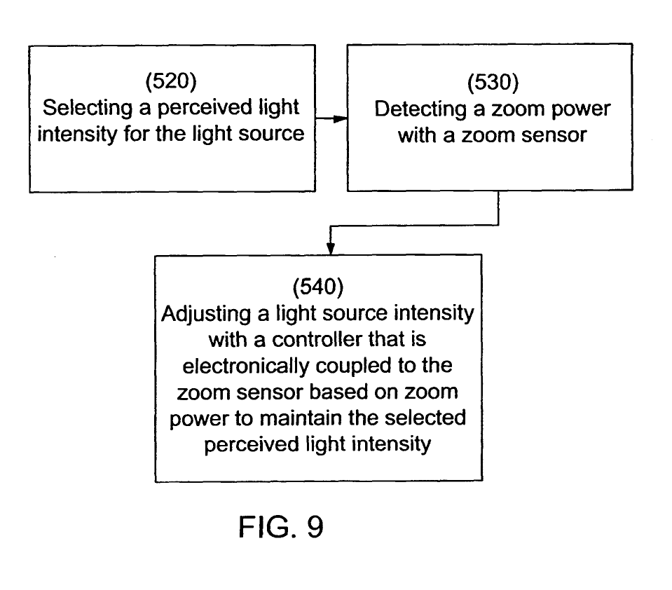

As explained above, because both the light intensity and zoom position may be tracked and controlled, a zoom control system in accordance with various embodiments may allow for an automatic tracking feature to be implemented. The automatic tracking feature may allow adjustment of the light intensity, such that the perceived light intensity remains generally fixed over the entire zoom range as perceived by the user. In various embodiments, as the user changes the zoom amount, the controller may change the light intensity in order to maintain the correct perceived light output. This may be generally referred to as the AUTO-TRAK mode. FIG. 9 illustrates the steps in an exemplary AUTO-TRAK mode, which corresponds to claim 16:

(520) selecting a perceived light intensity for the light source;

(530) detecting a zoom power with a zoom sensor; and

(540) adjusting a light source intensity with a controller that is electronically coupled to the zoom sensor based on the zoom power to maintain the selected perceived light intensity.

Various means for controlling light intensity are known to those of skill in the art. In one specific, non-limiting example, the light intensity is controlled by means of a wheel with a slot of a varying width about its circumference through which the light beam passes. In embodiments, rotation of the wheel can allow for minimal or no light to full light output, depending on the width of the portion of the slot through which the light beam passes. In another specific, non-limiting example, the light intensity is controlled by an iris-shaped device with a variable aperture size. In various embodiments, little or no light may pass through the aperture when closed, and full light output may pass through the aperture when fully open. In various embodiments, control of the light control device may be automatic, as in the AUTO-TRAK mode. In some embodiments, a manual control interface may be used to override the AUTO-TRAK mode, such as a foot switch or hand switch.

In various embodiments, the upper limit of light intensity may be controllably set to a predetermined level. Light-induced retinal damage (phototoxicity) is a well-recognized complication following ocular surgery, including cataract extractions, anterior segment procedures, and vitrectomy surgery. An increased risk of phototoxicity is associated with long exposure times and high light intensities from surgical microscope light sources. Thus, in some embodiments, the light intensity may be set to a predetermined safe level that is appropriate for the task at hand (e.g., the light intensity for eye surgery would be set lower than the level for ear surgery). This may be generally referred to herein as the SAFE-EYE mode. If selected, this mode may limit the maximum light output to a safe, predetermined or user-defined value, even in AUTO-TRACK mode.

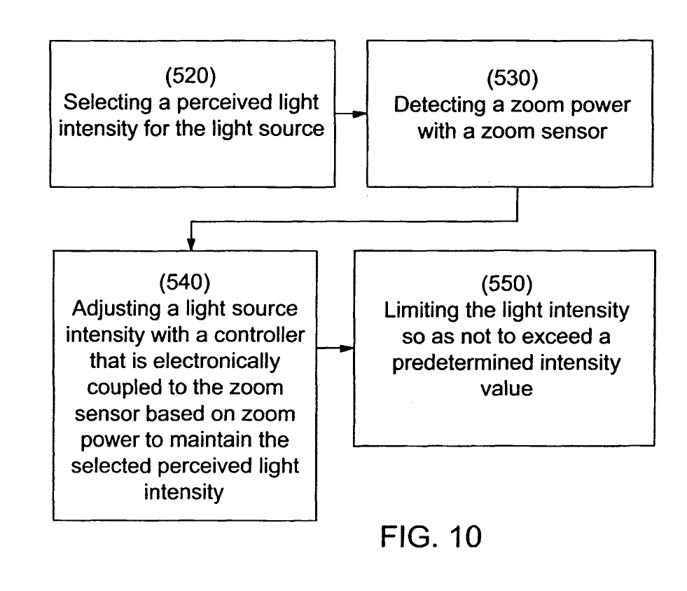

FIG. 10 illustrates the steps in an exemplary SAFE-EYE mode, used in combination with AUTO-TRAK, which corresponds to claim 19. The steps include the features of AUTO-TRAK as shown in FIG. 9, plus one additional step:

(520) selecting a perceived light intensity for the light source;

(530) detecting a zoom power with a zoom sensor;

(540) adjusting a light source intensity with a controller that is electronically coupled to the zoom sensor based on the zoom power to maintain the selected perceived light intensity; and

(550) limiting the light intensity so as not to exceed a predetermined intensity value.

In various embodiments, a controller also may automatically control the light intensity from the time the light system is powered up. In embodiments, as the lights in the system power up, a method of gradually increasing the light intensity from the time the system is powered may help ensure safe but effective levels of light. For instance, in one embodiment, at start up, the system light intensity may be set at a percentage of a known safe value for light exposure to a human eye, for example 10%, 20%, 30%, or 40% of a known safe value for light intensity, thus allowing the user to start a procedure at a useful, but safe level of light output.

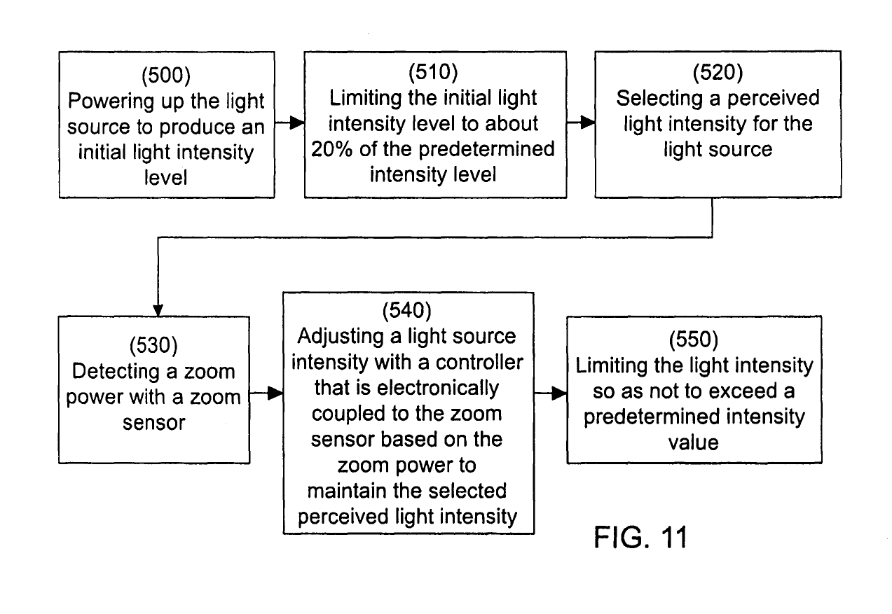

FIG. 11 illustrates the steps in another exemplary SAFE-EYE mode, used in combination with AUTO-TRAK. The steps include the features of SAFE-EYE and AUTO-TRAK as shown in FIG. 10, plus two additional steps, which corresponds to claim 29:

(500) powering up the light source to produce an initial light intensity level;

(510) limiting the initial light intensity level to about 20% of the predetermined intensity level;

(520) selecting a perceived light intensity for the light source;

(530) detecting a zoom power with a zoom sensor;

(540) adjusting a light source intensity with a controller that is electronically coupled to the zoom sensor based on the zoom power to maintain the selected perceived light intensity; and

(550) limiting the light intensity so as not to exceed a predetermined intensity value.

Together, these measures allow the use of the full safe range of light intensities for surgical procedures requiring maximal safe illumination, while still preventing phototoxic retinal damage. When SAFE-EYE is not implemented, then the full range of light intensity is available to the surgeon, and light intensity may be controlled by the controller or manually as previously discussed.

### 3. Monitoring and Assistant User Interface

In performing ophthalmologic, otologic, and other delicate procedures, magnification and stereoscopic vision (e.g., depth perception) are essential to the surgeon. With traditional surgical microscopes, only the operating surgeon is able to see the operative site through the microscope, thus reducing the assistant's ability to visualize and participate in the surgery. Current microscopes may include an auxiliary viewing port attached to the microscope body, which may allow an assistant, for instance, a second surgeon or a scrub nurse, to view the operative field when looking through the binocular eyepieces. However, while auxiliary viewing systems are binocular, they are not stereoscopic, which limits the assistant's depth perception, and thereby limits the assistant's ability to safely participate in the procedure. Additionally, because traditional auxiliary viewing ports provide the assistant with the same field of view in the same orientation as the surgeon (albeit in a non-stereoscopic form), the assistant's field of view will not be properly oriented according to the assistant's physical position relative to the surgical field. In addition to orientation problems, current assistant accessory viewing systems only allow for a small amount of movement relative to the main viewing port. Thus, these auxiliary viewing ports are cumbersome and difficult for the assistants to use for lengthy operative procedures.

Accordingly, in various embodiments in accordance with the present invention, one or more monitor screens, such as a flat screen LCD, LED, or plasma monitor, may be coupled to the microscope body and adapted to rotate about the microscope body or the axis of the light source. In various embodiments, it may rotate up to, for example, 330 degrees, and in one specific, non-limiting example, it may rotate about 280 degrees. Such rotational movement can allow for the auxiliary viewing system to be viewed from any position about the microscope, generally other than the position being occupied by the surgeon. In some embodiments, a camera may take binocular feeds and relay the image directly to the auxiliary viewing monitor. In some embodiments, this may be in addition to or in lieu of a current auxiliary viewing apparatus having traditional eyepieces. In other embodiments, the monitor can be rotated about a light path axis so that the assistant may view the field of operation from any number of positions about the microscope and assist as needed. Such auxiliary viewing monitors, in accordance with various embodiments, can supplant the prior ergonomically incorrect binocular assistant viewing systems, and further allow for multiple assistants or other persons to view the procedure.

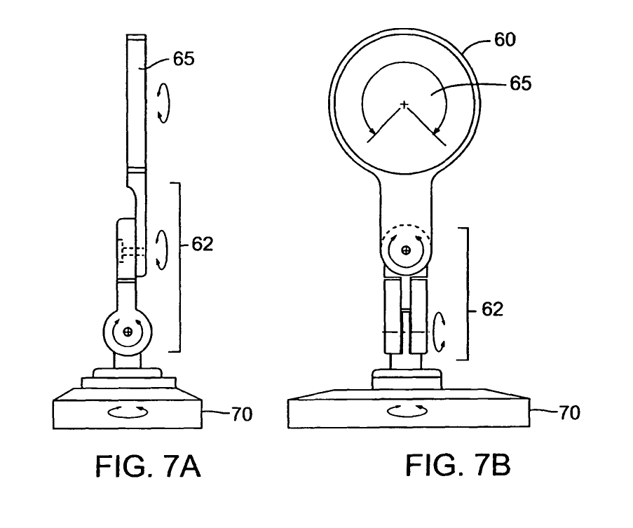

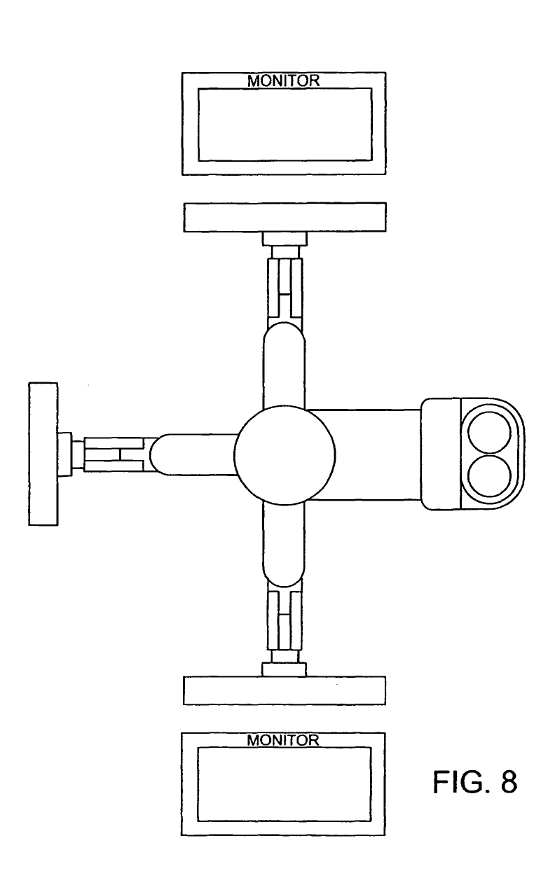

In various embodiments, the auxiliary viewing system monitor may include a monitor screen that can display a “true view” of the surgeon's field of view as viewed from any position around the microscope. For example, the monitor may not only be rotatable about the light path axis, but it may also be rotated about an axis generally transverse to the light path axis so that the viewer can maintain the orientation of the field of operation as seen by the surgeon, yet provide a real position based on the location of the screen and/or the assistant. FIGS. 7A and 7B illustrate top and side views of an exemplary mounting arm and monitor that permits such rotation.

In various embodiments, the video feed may be coupled to a positional sensor that senses the position of the monitor and sends a signal to a controller (e.g., a computer) that processes the positional information and properly orients the image based on the relative position of the screen as it is rotated about the axis of the light path. This system may be generally referred to as a “TRU-VIEW” system. In other embodiments, the monitor may be mechanically coupled to the microscope, for instance via gears, such that rotation of the monitor about the light path axis causes the monitor to rotate physically to maintain the proper image orientation throughout the range or rotation.

TRU-VIEW systems in accordance with various embodiments can significantly reduce the awkward positions that the assistants must adopt using existing binocular eyepiece viewing interfaces. This may not only greatly increase the assistant's awareness of the surgeon's progress and reduce the necessary work load to properly assist, but it can also help allow the assistant to be positioned farther from the microscope, increasing both the surgeon's and assistant's comfort and range of movement.

FIGS. 7A and 7B illustrate a top and side view of an auxiliary monitoring system in accordance with various embodiments. A collar 60 may be coupled to the microscope body, and may be adapted to generally rotate about the microscope body and/or the axis of the light path to a desired degree. A monitor 70 may be coupled to the collar 60 via an articulating linkage 62, which allows multi-way adjustment of the monitor 70 in the X, Y, and Z directions with respect to the microscope body 65.

In various embodiments, the collar 60 may be adapted to rotate less than a full 360 degrees. In one embodiment, a stop 64 may be disposed about the microscope body 65 and configured to limit the range of rotation of the collar, and thus the range of rotation of the monitor 70. In one embodiment, the rotation may be limited to between 25 and 300 degrees.

In various embodiments, two camera feeds, e.g., one taken from the right viewing port and the left viewing port, may be taken and fed to a stereo graphic viewing interface, such as LCD stereographic video glasses. Such a configuration may give the assistant or observer stereographic depth of field viewing of the surgical field.

In other embodiments where dual stereographic viewing is required, for instance in complex surgeries such as limb or digit reattachment surgeries requiring more than one surgeon, a dual-headed microscope is provided that includes a second zoom control system and a second pair of eyepieces (e.g., a diploscope). These double microscopes may also include one or more TRU-VIEW monitors for use by one or more assistants. Finally, in various embodiments, the system may include a TV feed to be applied to an external screen for group viewing. In various embodiments, the microscope system may allow for stored user presets, e.g., by user name or operation type, giving multiple users preferred settings of movement speeds, initial position and intensity settings.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A microscope comprising:
a plurality of lenses for magnifying an image of an object in a work area,
a zoom control system comprising a cylindrical cam having a plurality of grooves, and a plurality of lens carriers each adapted to carry two or more lenses, wherein the plurality of lens carriers each has a cam follower that engages a corresponding one of the grooves such that rotation of the solid cylindrical cam controls spacing between the lens carriers and the two or more lenses; and
a light source for illuminating the work area, wherein the illuminated work area reflects light through the optical elements, thereby assisting in the magnification and illumination of the image of the object.

2. The microscope of claim 1, further comprising an eyepiece adapted for viewing an object in the work area through the optical elements, the eyepiece having an optical axis which defines a projected line of sight through the eyepiece, the projected line of sight generally intersecting the optical axis at the work area.

3. The microscope of claim 1, wherein the zoom control system comprises a zoom sensor that detects the zoom power, wherein the zoom sensor is coupled to a light source controller, and wherein the light source controller adjusts the light source based on the zoom power.

4. The microscope of claim 1, wherein the microscope further comprises an auxiliary viewing system, the auxiliary viewing system comprising:
a monitor rotatably coupled to the microscope such that the monitor can rotate about a light beam axis of the microscope;
an image detector electronically coupled to the monitor, wherein the image detector receives a video image from the microscope, and wherein the monitor displays the video image.

5. A compact zoom system for a microscope comprising:
a solid cylindrical cam comprising a plurality of grooves; and
a corresponding plurality of lens carriers coupled to the grooves such that rotation of the solid cylindrical cam controls spacing between the lens carriers, thereby modifying the zoom.

6. The compact zoom system of claim 5, wherein the grooves comprise a first groove, a second groove, and a third groove; wherein the lens carriers comprise a first lens carrier, a second lens carrier, and a third lens carrier; and wherein the first lens carrier is movably coupled to the first groove, the second lens carrier is movably coupled to the second groove, and the third lens carrier is movably coupled to the third groove.

7. The compact zoom system of claim 5, wherein each lens carrier comprises two objective lenses having an objective spacing of greater than 25 mm.

8. The compact zoom system of claim 5, wherein the objective spacing is about 38 mm.

9. The compact zoom system of claim 5, wherein a limiting aperture has a diameter of greater than 8 mm.

10. The compact zoom system of claim 5, further comprising a drive system coupled to the cylindrical cam, wherein the drive system is configured to rotate the cylindrical cam.

11. The compact zoom system of claim 10, wherein the drive system is coupled to the solid cylindrical cam via a slip coupling, and wherein the slip coupling is adapted to disengage the drive system when the cylindrical cam has rotated to a maximum rotation point.

12. The compact zoom system of claim 11, wherein the drive system comprises a manual override, and where the manual override is configured to override the drive system.

13. The compact zoom system of claim 5, further comprising a zoom sensor configured to detect a zoom level.

14. The compact zoom system of claim 12, wherein the zoom sensor is coupled to the cylindrical cam and configured to detect rotation of the solid cylindrical cam.

15. An automated method of regulating a microscope light source, comprising:
selecting a perceived light intensity for the light source;
detecting a zoom power with a zoom sensor; and
adjusting a light source intensity based on the zoom power with a controller that is electronically coupled to the zoom sensor to maintain the selected perceived light intensity.

16. The method of claim 15, wherein adjusting the light source based on the zoom power to maintain the selected perceived light intensity comprises increasing the light intensity with increased zoom power and decreasing the light intensity with decreased zoom power.

17. The method of claim 16, wherein adjusting the light source intensity comprises varying a size of an aperture through which a light beam produced by the light source passes.

18. The method of claim 15, further comprising limiting the light intensity so as not to exceed a predetermined intensity value.

19. The method of claim 18, further comprising selecting the predetermined intensity value.

20. The method of claim 19, wherein selecting the predetermined intensity value comprises selecting a maximum light intensity level that will not cause retinal phototoxicity.

21. The method of claim 18, further comprising:
powering up the light source to produce an initial light intensity level; and
limiting the initial light intensity level to about 20% of the predetermined intensity level.

22. An auxiliary viewing system for a microscope comprising:
a monitor rotatably coupled to the microscope such that the monitor can rotate about a light beam axis of the microscope;
an image detector electronically coupled to the monitor, wherein the image detector receives a video image from the microscope, and wherein the monitor displays the video image.

23. The auxiliary viewing system of claim 22, wherein the monitor rotates in the direction generally transverse to the light beam axis of the microscope.

24. The auxiliary viewing system of claim 22, further comprising a rotational sensor that senses a degree of rotation of the monitor about the light beam axis of the microscope; wherein the rotational sensor is electronically coupled to a controller; and wherein the controller rotates the video image displayed on the monitor based on the degree of rotation detected by the sensor.
